(19) United States
(12) Patent Application Publication
(10) Pub. No.: US 2023/0327997 A1
(43) Pub. Date: Oct. 12, 2023

(54) Methods and Apparatuses for Providing Quality of Service Handling of User Traffic Transmitted by a Content Provider

(71) Applicant: Telefonaktiebolaget LM Ericsson (publ), Stockholm (SE)

(72) Inventor: Miguel Angel Muñoz De La Torre Alonso, Madrid (ES)

(21) Appl. No.: 18/022,293

(22) PCT Filed: Oct. 23, 2020
(86) PCT No.: PCT/EP2020/079875

§ 371 Date: Feb. 21, 2023

(30) Foreign Application Priority Data
Aug. 31, 2020 (EP) 20382771.2

(51) Int. Cl. H04L 47/2483; H04L 45/302; H04L 65/1073

(52) U.S. Cl. CPC H04L 47/2483; H04L 45/302; H04L 65/1073

(57) ABSTRACT

Embodiments described herein relate to methods and apparatuses for providing quality of service handling of user traffic transmitted by a first content provider. A method in a first network function comprises receiving an onboarding request from the first content provider, wherein the onboarding request comprises information relating to a QoS handling service that the first content provider supports.

### TECHNICAL FIELD

Embodiments described herein relate to methods and apparatuses for providing quality of service handling of user traffic transmitted by a first content provider. The first content provider may comprise an application client (for example a user equipment) or an application service.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

FIG. 1 illustrates a 5G network architecture as defined by 3GPP specifications.

For simplicity only the relevant network functions referred to in the Description below are outlined here.

The Application Function (AF) interacts with the 3GPP Core Network through the Network Exposure Function (NEF) to provide application services.

The NEF supports different functionality and specifically in the context of this application, the NEF acts as an entry point for an external AF into a network operator's network.

The Policy Control Function (PCF) supports a unified policy framework to govern the network behaviour.

The Network Resource function (NRF) supports registration and discovery procedures for network functions.

The use of traffic encryption is increasing significantly in mobile networks and at the same time, the encryption mechanisms are growing in complexity. In particular, most applications today are not based on HTTP cleartext, but instead they are based on HTTPS (using Transport Layer Security (TLS)). Additionally, a significant part of the traffic is based on QUIC transport, which has an encryption level higher than TLS. In the future, it is foreseen that the traffic from applications will be based on QUIC transport.

The TLS protocol specifies an extension known as Server Name Indication (SNI). It is common for content servers to host multiple origins behind a single IP-address. In order to route application flows to the correct server without having to decrypt the entire flow, the SNI extension was introduced. The SNI extension is sent by the client in the Client Hello message and contains a clear text string of the domain name of the server that the client is attempting to connect to. Since the SNI field is sent in clear text, it is commonly used by on-path network elements in order to classify flows.

At IETF, for TLS 1.3, it is proposed to encrypt the Server Name Indication (SNI) extension. There are several IETF drafts on this, specifically draft-ietf-tls-esni-05, which has been adopted by the TLS working group.

QUIC (Quick UDP Internet Connection) is a UDP-based, stream-multiplexing, encrypted transport protocol. QUIC is basically a UDP based replacement for TCP.

QUIC is now under standardization at IETF and relies on TLS 1.3, so QUIC based applications will also have the Server Name Indication (SNI) extension encrypted.

DNS is one of the fundamental building blocks of the Internet. It's used any time you visit a website, send an email, have an IM conversation or do anything else online.

When a user opens an application, DNS protocol is used to retrieve the server IP address/es for the target application domain. DNS protocol today is usually unencrypted (DNS over UDP/TCP), but there are different IETF drafts proposing DNS encryption to prevent middleboxes to detect DNS traffic. There are different proposals at IETF like DNSSEC, DNS over HTTP/2 (DOH), DNSCrypt, Quad9, etc. It is foreseen that in the 5G timeframe (2020-2030 decade) most DNS traffic will be encrypted.

### SUMMARY

According to some embodiments there is provided a method, in a first network function, for providing quality of service handling of user traffic transmitted by a first content provider. The method comprises receiving an onboarding request from the first content provider, wherein the onboarding request comprises information relating to a Quality of Service, QoS, handling service that the first content provider supports.

According to some embodiments there is provided a method, in a second network function, for providing quality of service handling of user traffic transmitted by a content provider. The method comprises receiving a registration request from a first network function, the registration request comprising first information relating to a Quality of Service, QoS, handling service that the content provider supports; and storing the first information.

According to some embodiments there is provided A method, in a third network function, for providing quality of service handling of user traffic transmitted by a content provider. The method comprises receiving a storing request from a first network function, wherein the storing request comprises information relating to a Quality of Service, QoS, handling service supported by the content provider; and storing the information relating to the QoS handling service.

According to some embodiments there is provided a method in a fourth network function for providing quality of service handling of user traffic transmitted by a content provider. The method comprises responsive to a session establishment message associated with a user identification, transmitting a query request for a policy data relating to the user identification to a third network function; and receiving policy information for the user identification relating to a Quality of Service, QoS, policy for a particular application.

According to some embodiments there is provided a method for providing quality of service handling of user traffic transmitted by a content provider. The method comprises receiving a quality of service request from a core network to apply a quality of service, QoS, handling action to first user traffic to be transmitted from the content provider; and applying the quality of service handling action to the first user traffic when transmitting the first user traffic.

According to some embodiments there is provided a method, in a core network, for providing quality of service handling of user traffic transmitted by a content provider. The method comprises transmitting a quality of service, QoS, request to a content provider to apply a QoS handling action to first user traffic to be transmitted from the content provider.

According to some embodiments there is provided a first network function for providing quality of service handling of user traffic transmitted by a first content provider. The first network function comprises processing circuitry configured to receive an onboarding request from the first content provider, wherein the onboarding request comprises information relating to a Quality of Service, QoS, handling service that the first content provider supports.

According to some embodiments there is provided a second network function for providing quality of service handling of user traffic transmitted by a content provider. The second network function comprises processing circuitry configured to: receive a registration request from a first network function, the registration request comprising first information relating to a Quality of Service, QoS, handling service that the content provider supports; and store the first information.

According to some embodiments there is provided a third network function for providing quality of service handling of user traffic transmitted by a content provider. The third network function comprises processing circuitry configured to: receive a storing request from a first network function, wherein the storing request comprises information relating to a Quality of Service, QoS, handling service supported by the content provider; and store the information relating to the QoS handling service. According to some embodiments there is provided a fourth network function for providing quality of service handling of user traffic transmitted by a content provider. The fourth network function comprises processing circuitry configured to: responsive to a session establishment message associated with a user identification, transmit a query request for a policy data relating to the user identification to a third network function; and receive policy information for the user identification relating to a Quality of Service, QoS, policy for a particular application.

According to some embodiments there is provided a content provider for providing quality of service handling of user traffic transmitted by the content provider. The content provider comprises processing circuitry configured to: receive a quality of service request from a core network to apply a quality of service, QoS, handling action to first user traffic to be transmitted from the content provider; and apply the quality of service handling action to the first user traffic when transmitting the first user traffic

According to some embodiments there is provided a core network for providing quality of service handling of user traffic transmitted by a content provider. The core network comprises processing circuitry configured to: transmit a quality of service, QoS, request to a content provider to apply a QoS handling action to first user traffic to be transmitted from the content provider.

### BRIEF DESCRIPTION OF THE FIGURES

For a better understanding of the embodiments of the present disclosure, and to show how it may be put into effect, reference will now be made, by way of example only, to the accompanying drawings, in which:

FIG. 1 illustrates an example of a 5G network architecture;

FIG. 2 illustrates a method, in a core network, for providing quality of service handling of user traffic transmitted by a content provider;

FIG. 3 illustrates a method for providing quality of service handling of user traffic transmitted by a content provider;

FIG. 4 illustrates an example signalling diagram implementing the methods of FIGS. 2 and 3;

FIG. 5 illustrates a method in a first network function for providing quality of service handling of user traffic transmitted by a first content provider;

FIG. 6 illustrates a method, in a second network function, for providing quality of service handling of user traffic transmitted by a content provider;

FIG. 7 illustrates a method, in a third network function, for providing quality of service handling of user traffic transmitted by a content provider;

FIG. 8 illustrates a method, in a fourth network function, for providing quality of service handling of user traffic transmitted by a content provider;

FIG. 9 illustrates a first network function comprising processing circuitry (or logic);

FIG. 10 illustrates a second network function comprising processing circuitry (or logic);

FIG. 11 illustrates a third network function comprising processing circuitry (or logic);

FIG. 12 illustrates a fourth network function comprising processing circuitry (or logic).

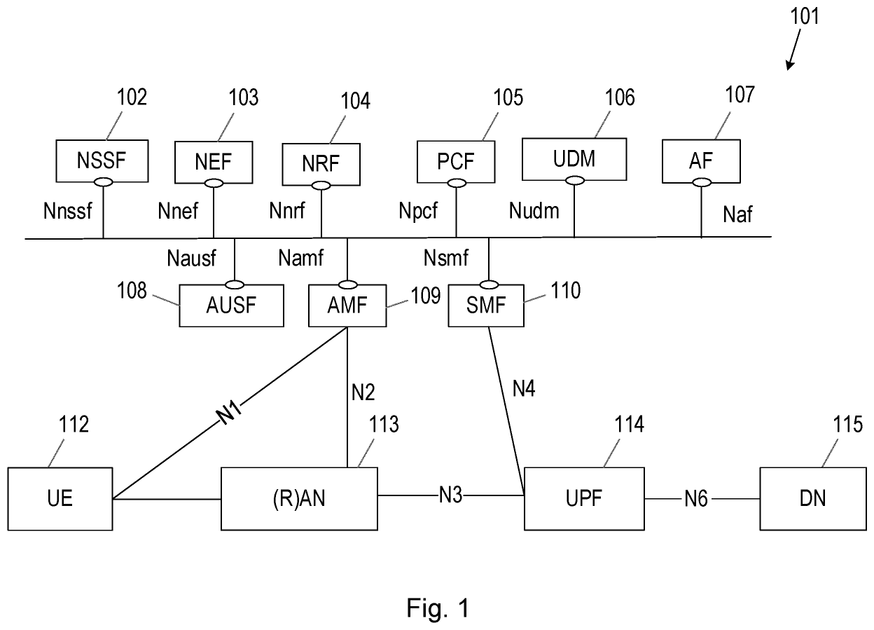

### DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Network operators today apply different traffic management actions, one of them being Quality of Service QoS handling. However, it is currently inefficient to control the user's traffic QoS. For example, as described above, user traffic encryption is in an increasing trend: HTTPS traffic (HTTP/HTTP2 over TLS) and now QUIC based applications (HTTP3 over QUIC), which makes it difficult to detect traffic on a per application basis, and therefore difficult to apply any QoS handling policy to the traffic on per application basis.

For video streaming applications (like YouTube), it is very difficult to identify video components and isolate them from the rest of the non-video application traffic.

Therefore, existing QoS handling when applied by the network operator to such encrypted traffic often results in the following undesirable effects on user's application traffic:
Packet loss
Rebuffering
Slow starts
Increased UE battery usage.

In embodiments described herein therefore, the QoS handling policy is applied by the content provider to the traffic, rather than being applied by the network operator. However, embodiments described herein provide a mechanism which is based on an extension of the exposure policy framework, specifically a QoS policy triggered by PCF and sent towards AF (through NEF), which allows the network operator to request that the content provider (which in this case comprises an application server) to apply a certain QoS handling for the user's traffic on a per application basis, in a simple and efficient way, especially when the traffic is encrypted (HTTPS/TLS or QUIC).

Similarly, it is proposed that a QoS policy triggered by PCF and sent towards a UE (through AMF), thereby allowing the network operator to request that the content provider (which in this case comprises an application client (UE)) to apply a certain QoS handling action for the user's traffic on a per application basis.

In order to implement the embodiments described below there may be a Service Level Agreement (SLA) between the content provider (be that an application service or an application client) and the network operator, according to which the content provider agrees to apply a QoS enforcement action that it is capable of supporting when requested to by the network operator.

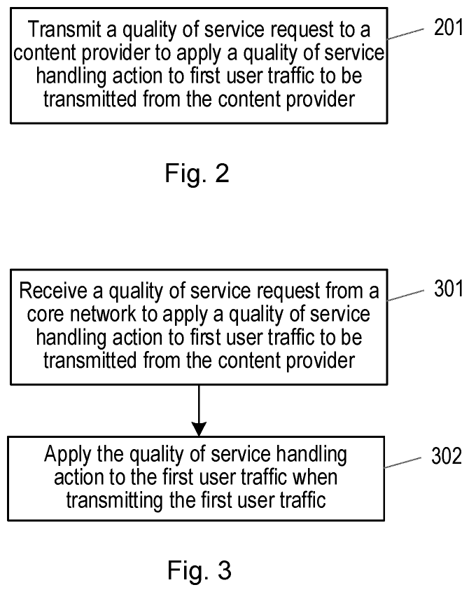

FIG. 2 illustrates a method, in a core network, for providing quality of service handling of user traffic transmitted by a content provider.

In step 201 the method comprises the core network transmitting a quality of service request to a content provider to apply a quality of service handling action to first user traffic to be transmitted from the content provider.

In response to this request, for example as agreed in an SLA between the network operator and the content provider, the content provider may perform the method as illustrated in FIG. 3.

FIG. 3 illustrates a method for providing quality of service handling of user traffic transmitted by a content provider. The method may be performed by the content provider. The content provider may comprise an application server or an application client (for example, a wireless device). In some examples, the content provider may communicate with the core network via an Application Function. The content provider may also, in some examples, further comprise an Application Function in communication with the core network. The AF (Application Function) may comprise an entity of the content provider communicating with the network operator's NEF. An identification AF-ID may identify the AF. The AS (Application Server) may comprise an entity of the content provider communicating with the Application Client (e.g. Netflix app client—at UE—communicates with the Netflix app server, not with the AF). In some embodiments, the AS and AF are co-located, in other embodiments they are not co-located.

In step 301, the method comprises receiving a quality of service request from a core network to apply a desired quality of service (QoS) handling service to first user traffic to be transmitted from the content provider.

In step 302, the method comprises applying the desired quality of service handling service to the first user traffic when transmitting the first user traffic.

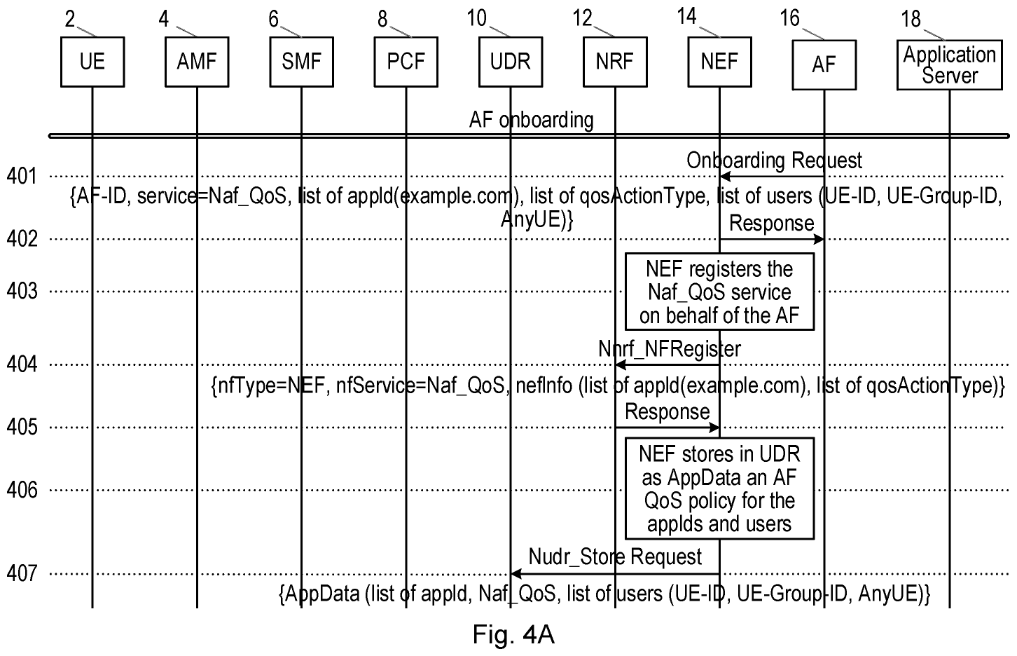

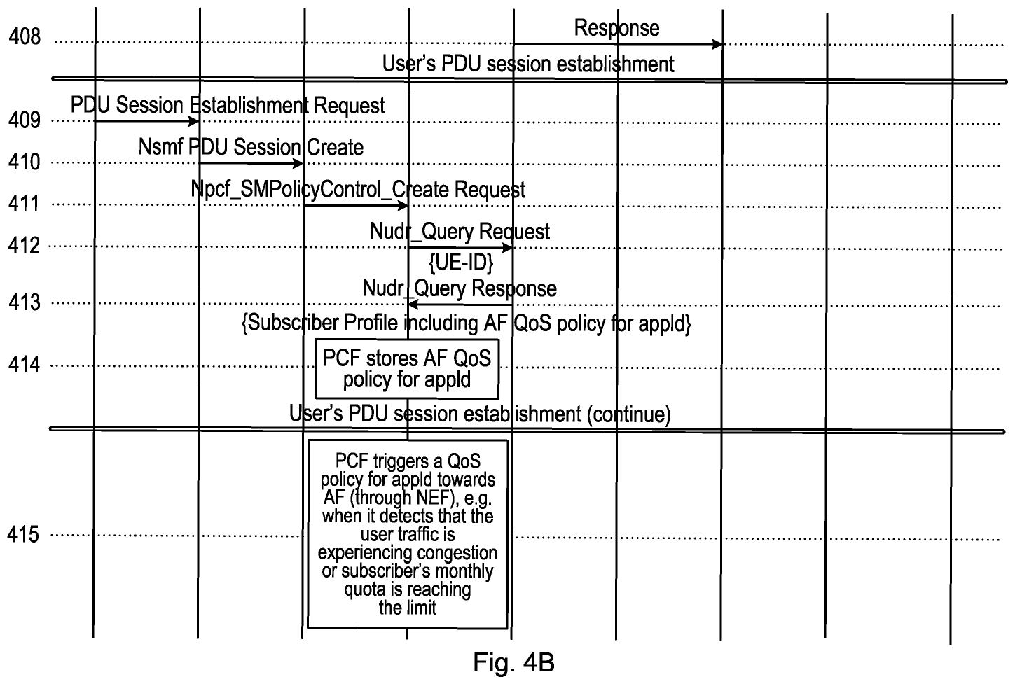

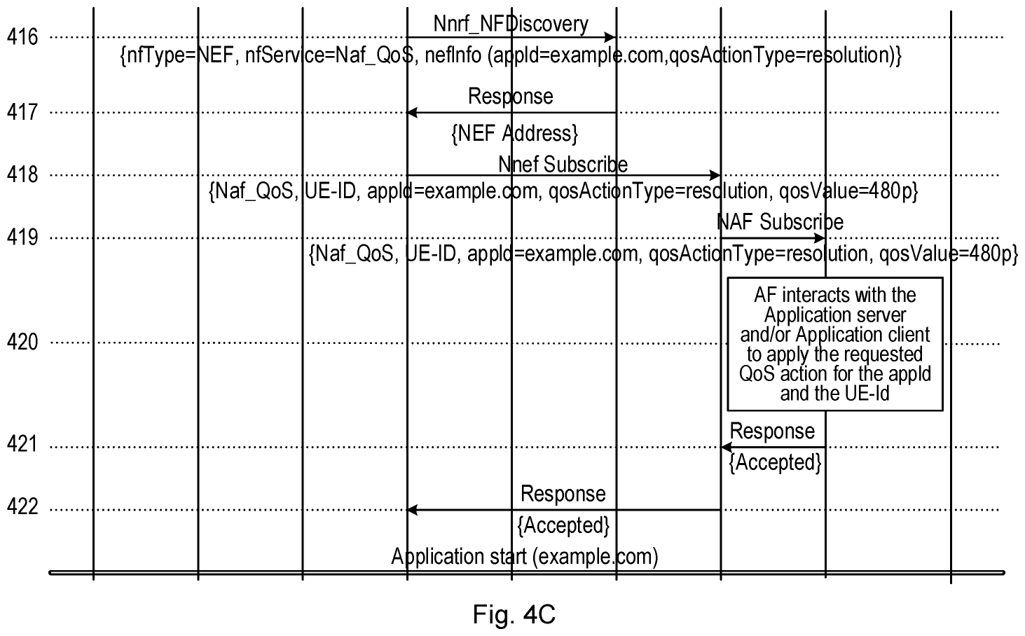

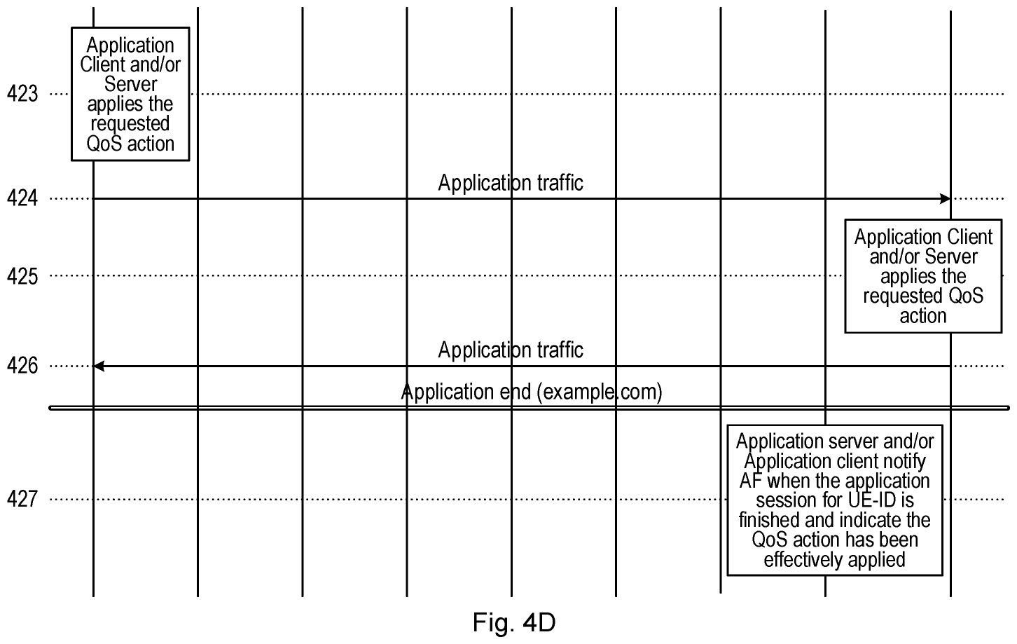

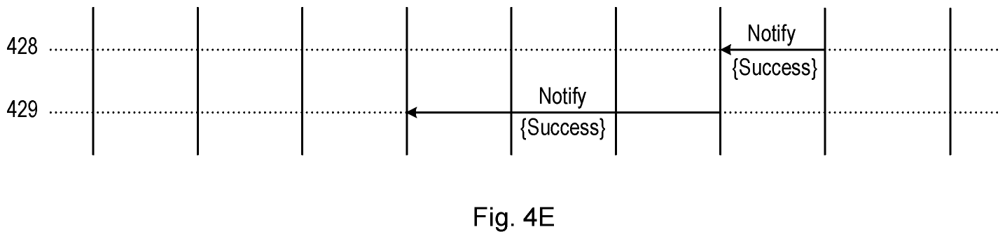

FIG. 4 illustrates an example signalling diagram implementing the methods of FIGS. 2 and 3. In this example the network functions of the 5G core network perform various steps in order to implement the method of FIG. 2. It will be appreciated, the different network functions may be utilised to implement the method, and that alternative signalling may be used.

In this example, the following network functions are utilised: the Access and Mobility Management Function (AMF) 4; the Session Management Function (SMF) 6, the Policy Control Function (PCF) 8, the Unified Data Repository (UDR) 10, the Network Repository Function (NRF) 12, the Network Exposure Function (NEF) 14, and the application function (AF) 16.

It will however, be appreciated that the embodiments described herein may be used in other architectures other than the 5G network architecture. For example, the same mechanisms may be applied to a 4G architecture, just by replacing:
AF by SCS/AS
NEF by SCEF
PCF by PCRF
SMF 6 by PGW-C or TDF-C
UPF by PGW-U or TDF-U

In step 401, The AF16 transmits an onboarding request to the NEF 14 on behalf of the content provider. The onboarding request comprises information relating to a QoS handling service supported by the content provider, in this example an application server.

In some examples, the information relating to the QoS handling service comprises one or more of: an identification of an application function of the first content provider (AF-ID); an identification of the QoS handling service (Naf QoS); one or more application identifications of applications to which the first content provider can provide the QoS handling service (list of appld(example.com); an indication of one or more QoS handling actions that are supported by the first content provider (list of qosActionType); one or more user identifications to which the first content provider can provide the QoS handling service (UE-ID, UE-Group-ID, AnyUE).

The one or more QoS handling actions that are supported by the first content provider may comprise one or more of: applying a particular bitrate to user traffic; applying a particular video resolution to video user traffic; reducing a video resolution of video user traffic to a lower level of resolution.

Optionally, the content provider might indicate to the network operator that the QoS service is to be applied at application client side (so the network operator might then trigger any QoS policy by instructing the application client).

In step 402, the NEF 14 acknowledges the onboarding request.

In step 403, the NEF 14 registers the QoS handling service on behalf of the AF. In order to perform this registration, the NEF 14 triggers the transmission of a registration request as described in step 404. In some examples, the AF 16 is a trusted function and is able to register the QoS handling service without needing the assistance of the NEF 14.

In step 404, the NEF 14 transmits a registration request (Nnrf_NFRegister) to the NRF to register the QoS handling service. The registration request may comprise at least part of the information relating to the QoS handling service. For example, the registration request may comprise the identification of the QoS handling service (Naf_QoS); the one or more application identifications of applications to which the first content provider can provide the QoS handling service (applD (example.com)); and the indication of one or more QoS handling actions that are supported by the first content provider (qosActionType). The NRF may store the information received in the registration request. The information may be stored locally at the NRF, or elsewhere in the network.

The registration request may also comprise an indication that of the type of network function transmitting the registration request, in this example, an NEF 14. It will be appreciated that the registration request may also be transmitted by a trusted AF.

In step 405, the NRF acknowledges the registration request.

In step 406, the NEF 14 stores in the UDR 10 an AF QoS policy for the applDs and users indicated in the registration request.

In step 407, the NEF 14 transmits a storing request to the UDR 10, wherein the storing request comprises at least part of the information relating to the QoS handling service. The storing request may comprise one or more of: the identification of the QoS handling service; the one or more application identifications of applications to which the first content provider can provide the QoS handling service; the one or more user identifications to which the first content provider can provide the QoS handling service; and the one or more QoS handling actions that are supported by the first content provider.

In step 408, the UDR 10 acknowledges the storing request. The UDR 10 may also store the at least part of the information received in the storing request. The UDR 10 may store the information as an AF QoS policy for the applD(s) and user(s) indicated in the storing request.

In step 409, an application client 2 triggers a PDU session establishment, by means of sending a PDU Session Establishment Request to the AMF 4. It will be appreciated that FIG. 4 does not include all the signalling messages involved in the PDU Session Establishment procedure.

In step 410, the AMF 4 selects an SMF 6 to manage the PDU session and triggers an NSMF 6 PDU Session Create message.

In step 411, the SMF 6 selects a PCF 8 and triggers an Npcf_SMPolicyControl_Create Request message to retrieve SM policies for the user PDU session.

In step 412, the PCF 8 triggers Nudr_Query Request message to the UDR 10 to retrieve the policy data for this user's PDU session. The query request may comprise the user identification (UE-ID).

The UDR 10 may then select a stored information entry that is associated with the user identification, wherein the stored information entry comprises policy information relating to a QoS policy for a particular application.

In step 413, the UDR 10 may transmit the policy information to the PCF 8. The UDR 10 may transmit the policy information with the Nudr_Query Response message including the Subscriber Profile. In this example the subscriber profile includes an AF QoS policy for appld (example.com).

In step 414, the PCF 8 stores the policy information. In particular the policy information in this example, comprises a QoS policy for the application example.com.

In step 415, the PCF 8 detects that the traffic associated with the user identification has met a predetermined condition. For example, the predetermined condition may comprise the user traffic experiencing a predetermined level of congestion, or the user traffic meeting or reaching the subscriber's monthly quota.

In step 416, the PCF 8 transmits a discovery request to the NRF 12 comprising information relating to a desired QoS handling service, wherein the desired QoS handling service is part of the QoS policy for the particular application.

In this example, the desired QoS handling service comprises a QoS handling service in which the resolution (e.g. 480 p) for the application example.com is set to a request resolution e.g. 480 p.

The discovery request may therefore comprise an Nnrf_NFDiscovery message towards NRF 12 including the following parameters:
nfType=NEF
nfService=Naf_QoS
neflnfo (appld=example.com, qosActionType=resolution)

The NRF 12 may then select a stored information entry that matches the information received in the discovery request. In other words, the NRF 12 may locate an NEF 14 capable of initiating the desired QoS handling service to set the resolution of the application example.com to 480 p. For example, the NEF 14 may initiate the desired QoS handling service by communicating with an AF 16 in communication with the content provider.

In this example, for simplicity, the NEF 14 is illustrated as the NEF capable of initiating the desired QoS handling service. It will however, be appreciated, that there may be a plurality of NEFs registered with the NRF 12, and that therefore the NRF 12 may select whichever registered NEF is initiating of providing the desired QoS handling service that has been indicated in the discovery request.

In step 417, the NRF 12 transmits an indication of the NEF 14 capable of initiating the desired QoS handling service to the PCF 8.

In step 418, the PCF 8 transmits a service request to the NEF 14 indicated in in step 417, The service request may request that the NEF 14 initiate performance of the desired QoS handling service.

In some examples, the service request comprises a subscription request. For example, the PCF 8 may subscribe to the Naf_QoS service through the NEF 14, by sending a Nnef subscribe message as the service request towards the NEF 14. The service request may comprise parameters describing the desired QoS handling service, for example:
Naf_QoS service—indicting the type of service
UE-ID—the UE to which the QoS handling action is to be applied
appld=example.com—the application to which the QoS handling actionis to be applied
qosActionType=resolution—the QoS handling action
qosValue=480 p—a value associated with the QoS handling action.

In this example therefore, the parameters outline a desired QoS handling service of: setting the resolution of application example.com traffic transmitted to the application client UE-ID to 480 p.

In embodiments where the service request comprises a subscription request, the network operator wants to be explicitly notified by the content provider that the desired QoS action has been effectively applied. In case the network operator does not want to be explicitly notified, the service request may instead trigger a response from the NEF 14 indicating that the service request has been accepted, without the need to be explicitly notified that the desired QoS handling service has been effectively applied.

In step 419, the NEF 14 forwards the service request to the AF 16 in communication with the content provider 18 capable of performing the desired QoS handling service. However, it will be appreciated, that a plurality of content providers may be registered with the network via the NEF 14. The NEF 14 may therefore select whichever AF 16 is in communication with a content provider is capable of performing the desired QoS handling service. In some examples, the content provider capable of providing the QoS handling service comprises an application client (for example, a user equipment).

In this example, the NEF 14 may therefore subscribe to the Naf_QoS service, by sending an Naf_subscribe message towards the AF. Similarly to as in step 418, the service request to the AF 16 may comprise parameters describing the desired QoS handling service. In this example, the included parameters are:
Naf_QoS service
UE-ID
appld=example.com
qosActionType=resolution
qosValue=480 p

In step 420 the AF 16 interacts with the content provider 16 (in this example, the application server) to apply the desired QoS handling service for the appld and the UE-ID (for example, as described with reference to FIG. 3). The detailed procedure on how to do this may be understood by those skilled in the art. For example, the desired resolution level, 480 p, might be sent to the application server (and/or in some examples, to the application client in the UE).

In step 421, the AF 16 accepts the subscription in step 420 above and NEF 14 forwards the acceptance to PCF 8.

In step 420, the NEF 14 forwards the response indicating acceptable of the subscription to the PCF 8.

In step 423, a user starts the application example.com and application traffic passes from the application client 2 to the application server 18 in step 424. The application server 18 (and/or, in some examples, the application client) applies the desired QoS handling service in step 425.

In this example, the desired QoS handling service is to applying the QoS handling action of setting the video resolution to 480 p for video traffic to the application example.com. Therefore, in step 426, when the application traffic for example.com (comprising video traffic) is transmitted back to the application client 2, the video traffic is set to a resolution of 480 p.

In step 427, the application server 18 (or application client) may notify the AF 16 when the application for the UE-ID is finished, and may indicate that the desired QoS handling service has been effectively applied.

In step 428, the AF 16 may forward the notification that the desired QoS handling service has been applied to the NEF 14. In step 429, the NEF 14 may forward the notification received in step 428 to the PCF 8.

In this example, it is assumed that the content provider 18 has been able to effectively apply the desired QoS handling service. In examples in which the content provider is not able to apply the desired QoS handling service, the notification message may indicate a non-successful operation. The PCF 8 might therefore install Policy and Charging Control (PCC) rules towards the SMF 6/UPF, so that the UPF applies the desired QoS handling service to the user traffic in instances in which the notification message indicates a non-successful operation. The network operator might also check (e.g. by requesting measurement actions towards UPF) whether the content provider is enforcing the desired QoS handling service properly or not.

In some examples, the desired QoS handling service may be provided by the application client, and may be triggered by the PCF 8, for example, via the AMF 4. This may allow the network operator to request that the application client apply the desired QoS handling service for the user's traffic on a per application basis.

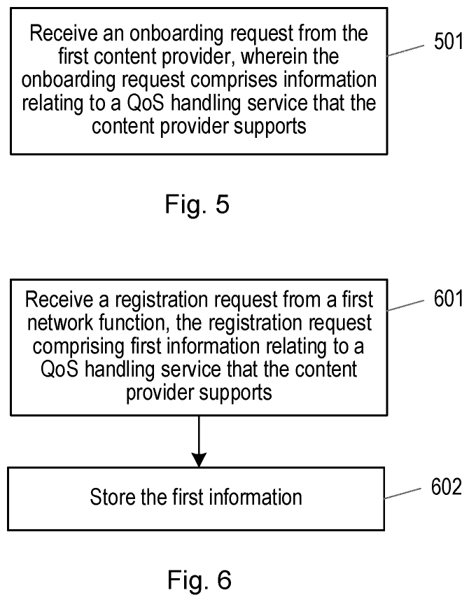

FIG. 5 illustrates a method in a first network function for providing quality of service handling of user traffic transmitted by a first content provider. The first network function may, for example, comprise an NEF such as NEF 14 as described with reference to FIG. 4.

In step 501, the first network function receiving an onboarding request transmitted by the first content provider (for example by an Application Function of the first content provider), wherein the onboarding request comprises information relating to a QoS handling service that the first content provider supports. Step 401 of FIG. 4 illustrates an example implementation of step 501.

FIG. 6 illustrates a method, in a second network function, for providing quality of service handling of user traffic transmitted by a content provider. The second network function may, for example, comprise an NRF such as NRF 12 as described with reference to FIG. 4.

In step 601, the second network function receives a registration request from a first network function (e.g. NEF 14), wherein the registration request comprises first information relating to a QoS handling service that the content provider supports. Step 404 illustrated in FIG. 4 is an example implementation of step 601.

In step 602, the second network function stores the first information. This information may be stored elsewhere in the network, or in cloud based services.

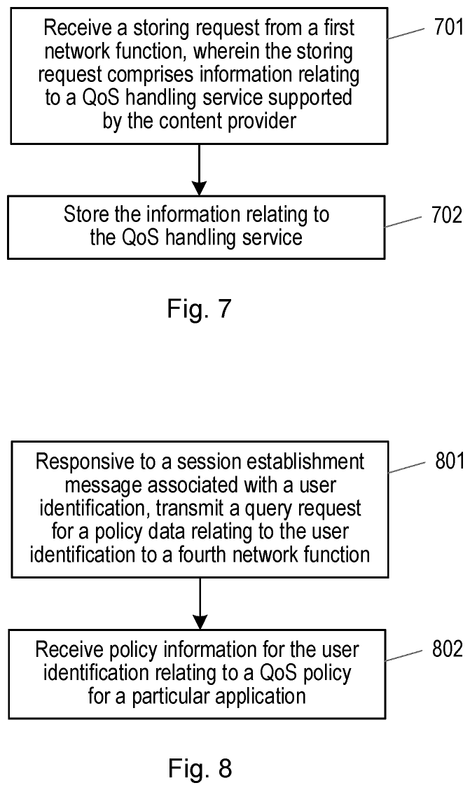

FIG. 7 illustrates a method, in a third network function, for providing quality of service handling of user traffic transmitted by a content provider. The third network function may comprise, for example, a UDR such as UDR 10 illustrated in FIG. 4.

In step 701, the third network function receives a storing request from a first network function (e.g. NEF 14), wherein the storing request comprises information relating to a QoS handling service supported by the content provider. Step 407 illustrated in FIG. 4 is an example implementation of step 701.

In step 702, the third network function stores the information relating to the QoS handling service.

FIG. 8 illustrates a method in a fourth network function, for providing quality of service handling of user traffic transmitted by a content provider. The fourth network function may comprise, for example, a PCF such as PCF 8 illustrated in FIG. 4.

In step 801, responsive to a session establishment message associated with a user identification, the fourth network function transmits a query request for a policy data relating to the user identification to a third network function (for example a UDR). Step 412 illustrated in FIG. 4 is an example implementation of step 801.

In step 802, the fourth network function receives policy information for the user identification relating to a QoS policy for a particular application. Step 413 illustrated in FIG. 4 is an example implementation of step 802.

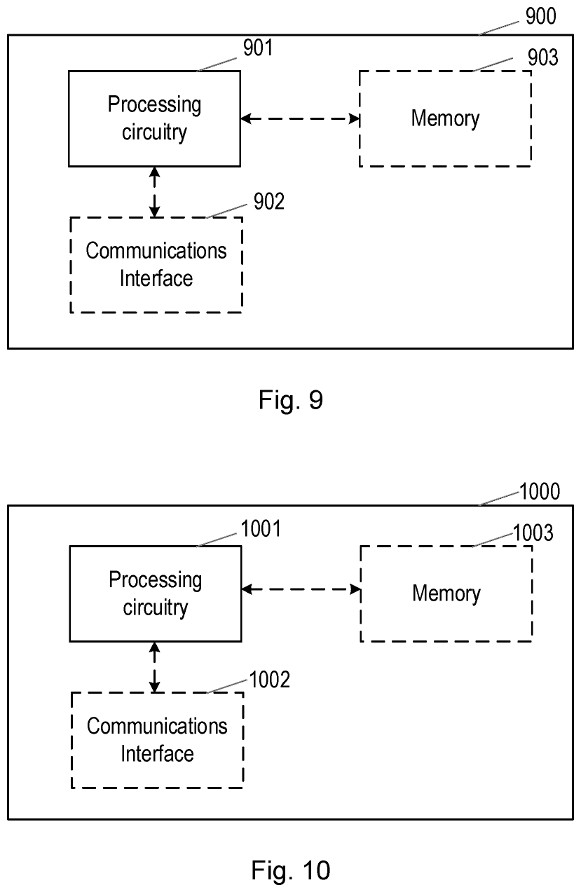

FIG. 9 illustrates a first network function 900 comprising processing circuitry (or logic) 901. The first network function 900 may comprise a NEF such as NEF 14 illustrated in FIG. 4. The processing circuitry 901 controls the operation of the first network function 900 and can implement the method described herein in relation to a first network function 900. The processing circuitry 901 can comprise one or more processors, processing units, multi-core processors or modules that are configured or programmed to control the first network function 900 in the manner described herein. In particular implementations, the processing circuitry 901 can comprise a plurality of software and/or hardware modules that are each configured to perform, or are for performing, individual or multiple steps of the method described herein in relation to the first network function 900.

Briefly, the processing circuitry 901 of the first network function 900 is configured to: receive an event subscription request from a network node subscribing for information relating to the reachability of a wireless device, the event subscription request comprising an indication of a reachability type; and responsive to receiving an indication of an event indicating a change in the reachability of the wireless device via the reachability type, transmit a notification to the network node indicating the reachability of the wireless device via the reachability type.

In some embodiments, the first network function 900 may optionally comprise a communications interface 902. The communications interface 902 of the first network function 900 can be for use in communicating with other nodes, such as other virtual nodes. For example, the communications interface 902 of the first network function 900 can be configured to transmit to and/or receive from other nodes requests, resources, information, data, signals, or similar. The processing circuitry 901 of first network function 900 may be configured to control the communications interface 902 of the first network function 900 to transmit to and/or receive from other nodes requests, resources, information, data, signals, or similar.

Optionally, the first network function 900 may comprise a memory 903. In some embodiments, the memory 903 of the first network function 900 can be configured to store program code that can be executed by the processing circuitry 901 of the first network function 900 to perform the method described herein in relation to the first network function 900. Alternatively or in addition, the memory 903 of the first network function 900, can be configured to store any requests, resources, information, data, signals, or similar that are described herein. The processing circuitry 901 of the first network function 900 may be configured to control the memory 903 of the first network function 900 to store any requests, resources, information, data, signals, or similar that are described herein.

FIG. 10 illustrates a second network function 1000 comprising processing circuitry (or logic) 1001. The second network function 1000 may comprise a NRF such as NRF 12 illustrated in FIG. 4. The processing circuitry 1001 controls the operation of the second network function 1000 and can implement the method described herein in relation to a second network function 1000. The processing circuitry 1001 can comprise one or more processors, processing units, multi-core processors or modules that are configured or programmed to control the second network function 1000 in the manner described herein. In particular implementations, the processing circuitry 1001 can comprise a plurality of software and/or hardware modules that are each configured to perform, or are for performing, individual or multiple steps of the method described herein in relation to the second network function 1000.

Briefly, the processing circuitry 1001 of the second network function 1000 is configured to: receive an event subscription request from a network node subscribing for information relating to the reachability of a wireless device, the event subscription request comprising an indication of a reachability type; and responsive to receiving an indication of an event indicating a change in the reachability of the wireless device via the reachability type, transmit a notification to the network node indicating the reachability of the wireless device via the reachability type.

In some embodiments, the second network function 1000 may optionally comprise a communications interface 1002. The communications interface 1002 of the second network function 1000 can be for use in communicating with other nodes, such as other virtual nodes. For example, the communications interface 1002 of the second network function 1000 can be configured to transmit to and/or receive from other nodes requests, resources, information, data, signals, or similar. The processing circuitry 1001 of second network function 1000 may be configured to control the communications interface 1002 of the second network function 1000 to transmit to and/or receive from other nodes requests, resources, information, data, signals, or similar.

Optionally, the second network function 1000 may comprise a memory 903. In some embodiments, the memory 1003 of the second network function 1000 can be configured to store program code that can be executed by the processing circuitry 1001 of the second network function 1000 to perform the method described herein in relation to the second network function 1000. Alternatively or in addition, the memory 1003 of the second network function 1000, can be configured to store any requests, resources, information, data, signals, or similar that are described herein. The processing circuitry 1001 of the second network function 1000 may be configured to control the memory 1003 of the second network function 1000 to store any requests, resources, information, data, signals, or similar that are described herein.

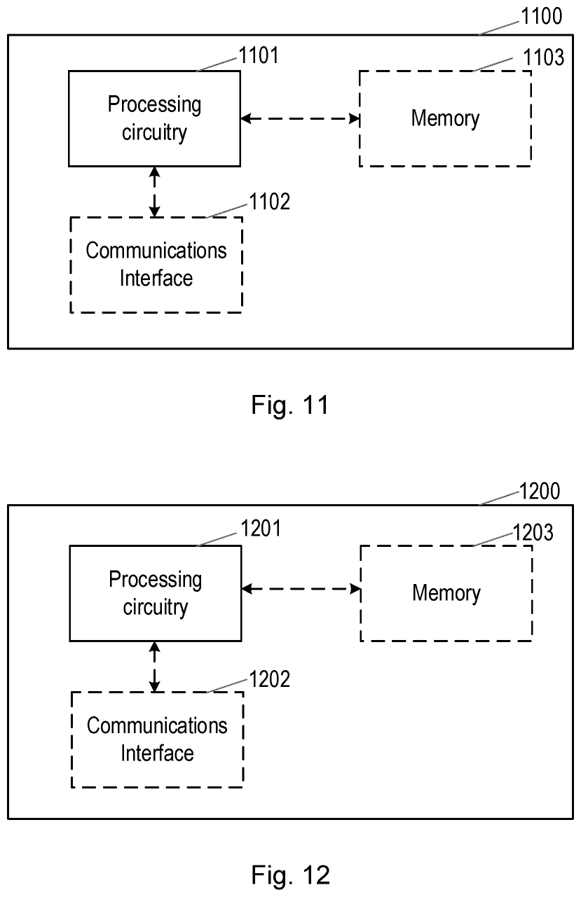

FIG. 11 illustrates a third network function 1100 comprising processing circuitry (or logic) 1101. The third network function 1100 may comprise a UDR such as UDR 10 illustrated in FIG. 4. The processing circuitry 1101 controls the operation of the third network function 1100 and can implement the method described herein in relation to a third network function 1100. The processing circuitry 1101 can comprise one or more processors, processing units, multi-core processors or modules that are configured or programmed to control the third network function 1100 in the manner described herein. In particular implementations, the processing circuitry 1101 can comprise a plurality of software and/or hardware modules that are each configured to perform, or are for performing, individual or multiple steps of the method described herein in relation to the third network function 1100.

Briefly, the processing circuitry 1101 of the third network function 1100 is configured to: receive an event subscription request from a network node subscribing for information relating to the reachability of a wireless device, the event subscription request comprising an indication of a reachability type; and responsive to receiving an indication of an event indicating a change in the reachability of the wireless device via the reachability type, transmit a notification to the network node indicating the reachability of the wireless device via the reachability type.

In some embodiments, the third network function 1100 may optionally comprise a communications interface 1102. The communications interface 1102 of the third network function 1100 can be for use in communicating with other nodes, such as other virtual nodes. For example, the communications interface 1102 of the third network function 1100 can be configured to transmit to and/or receive from other nodes requests, resources, information, data, signals, or similar. The processing circuitry 1101 of third network function 1100 may be configured to control the communications interface 1102 of the third network function 1100 to transmit to and/or receive from other nodes requests, resources, information, data, signals, or similar.

Optionally, the third network function 1100 may comprise a memory 1103. In some embodiments, the memory 1103 of the third network function 1100 can be configured to store program code that can be executed by the processing circuitry 1101 of the third network function 1100 to perform the method described herein in relation to the third network function 1100. Alternatively or in addition, the memory 1103 of the third network function 1100, can be configured to store any requests, resources, information, data, signals, or similar that are described herein. The processing circuitry 1101 of the third network function 1100 may be configured to control the memory 1103 of the third network function 1100 to store any requests, resources, information, data, signals, or similar that are described herein.

FIG. 12 illustrates a fourth network function 1200 comprising processing circuitry (or logic) 1201. The fourth network function 1200 may comprise a PCF such as PCF 8 illustrated in FIG. 4. The processing circuitry 1201 controls the operation of the fourth network function 1200 and can implement the method described herein in relation to a fourth network function 1200. The processing circuitry 1201 can comprise one or more processors, processing units, multi-core processors or modules that are configured or programmed to control the fourth network function 1200 in the manner described herein. In particular implementations, the processing circuitry 1201 can comprise a plurality of software and/or hardware modules that are each configured to perform, or are for performing, individual or multiple steps of the method described herein in relation to the fourth network function 1200.

Briefly, the processing circuitry 1201 of the fourth network function 1200 is configured to: receive an event subscription request from a network node subscribing for information relating to the reachability of a wireless device, the event subscription request comprising an indication of a reachability type; and responsive to receiving an indication of an event indicating a change in the reachability of the wireless device via the reachability type, transmit a notification to the network node indicating the reachability of the wireless device via the reachability type.

In some embodiments, the fourth network function 1200 may optionally comprise a communications interface 1202. The communications interface 1202 of the fourth network function 1200 can be for use in communicating with other nodes, such as other virtual nodes. For example, the communications interface 1202 of the fourth network function 1200 can be configured to transmit to and/or receive from other nodes requests, resources, information, data, signals, or similar. The processing circuitry 1201 of fourth network function 1200 may be configured to control the communications interface 1202 of the fourth network function 1200 to transmit to and/or receive from other nodes requests, resources, information, data, signals, or similar.

Optionally, the fourth network function 1200 may comprise a memory 1203. In some embodiments, the memory 1203 of the fourth network function 1200 can be configured to store program code that can be executed by the processing circuitry 1201 of the fourth network function 1200 to perform the method described herein in relation to the fourth network function 1200. Alternatively or in addition, the memory 1203 of the fourth network function 1200, can be configured to store any requests, resources, information, data, signals, or similar that are described herein. The processing circuitry 1201 of the fourth network function 1200 may be configured to control the memory 1203 of the fourth network function 1200 to store any requests, resources, information, data, signals, or similar that are described herein.

Embodiments described herein describe methods and apparatus for providing quality of service handling of user traffic transmitted by a first content provider.

Advantages of the embodiments described herein comprise:

allowing the network operator to control QoS handling in a simple and efficient way, For example, compared to the existing QoS handling mechanisms, e.g. ABR shaping, throttling, etc. the embodiments described herein provide:
Faster restarts
Less rebuffering
Lower battery usage
A working solution even when the traffic is encrypted, e.g. HTTPS (TLS) or QUIC based applications.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-54. (canceled).

55. A method, in a first network function, for providing quality of service handling of user traffic transmitted by a first content provider, the method comprising:
receiving an onboarding request from the first content provider, wherein the onboarding request comprises information relating to a Quality of Service, QoS, handling service that the first content provider supports.

56. The method of claim 55, wherein the information relating to the QoS handling service comprises one or more of:
an identification of the first content provider;
an identification of the QoS handling service;
one or more application identifications of applications to which the first content provider can provide the QoS handling service;
an indication of one or more QoS handling actions that are supported by the first content provider; and
one or more user identifications to which the first content provider can provide the QoS handling service.

57. The method of claim 56, wherein the one or more QoS handling actions that are supported by the first content provider comprises one or more of:
applying a particular bitrate to user traffic;
applying a particular video resolution to video user traffic;
reducing a video resolution of video user traffic to a lower level of resolution.

58. The method of claim 56, further comprising transmitting a registration request to register the QoS handling service with a second network function, wherein the registration request comprises at least part of the information relating to the QoS handling service.

59. The method of claim 58, wherein the registration request comprises:
the identification of the QoS handling service;
the one or more application identifications of applications to which the first content provider can provide the QoS handling service; and
the indication of one or more QoS handling actions that are supported by the first content provider.

60. The method of claim 56, further comprising transmitting a storing request to a third network function, wherein the storing request comprises at least part of the information relating to the QoS handling service.

61. The method of claim 60, wherein the storing request comprises one or more of:
the identification of the QoS handling service;
the one or more application identifications of applications to which the first content provider can provide the QoS handling service;
the one or more user identifications to which the first content provider can provide the QoS handling service; and
the indication of one or more QoS handling actions that are supported by the first content provider.

62. The method of claim 55, further comprising receiving a service request from a fourth network function to initiate performance of a desired QoS handling service.

63. The method of claim 62, further comprising forwarding the service request to a second content provider capable of providing the desired QoS handling service, wherein the second content provider comprises one of the first content provider and a different content provider to the first content provider.

64. The method of claim 63, wherein the method further comprises receiving a response from the second content provider indicating that the service request is accepted.

65. The method of claim 63, wherein the service request comprises a subscription request, and wherein the method further comprises receiving a notification from the second content provider when the desired QoS handling service has been effectively applied.

66. A method, in a second network function, for providing quality of service handling of user traffic transmitted by a content provider, the method comprising:
receiving a registration request from a first network function, the registration request comprising first information relating to a Quality of Service, QoS, handling service that the content provider supports; and
storing the first information.

67. The method of claim 66, wherein the first information comprises:
an identification of a QoS handling service;
one or more application identifications of applications to which the content provider can provide the QoS handling service; and
an indication of one or more QoS handling actions that are supported by the content provider.

68. The method of claim 66, further comprising receiving a discovery request from a fourth network function wherein the discovery request comprises second information relating to a desired QoS handling service.

69. The method of claim 68, further comprising:
selecting a stored information entry that matches the second information, and
transmitting an indication of a fifth network function associated with the stored information entry to the third network function.

70. A first network function for providing quality of service handling of user traffic transmitted by a first content provider, the first network function comprising processing circuitry configured to:
receive an onboarding request from the first content provider, wherein the onboarding request comprises information relating to a Quality of Service, QoS, handling service that the first content provider supports.

71. A second network function for providing quality of service handling of user traffic transmitted by a content provider, the second network function comprising processing circuitry configured to:
receive a registration request from a first network function, the registration request comprising first information relating to a Quality of Service, QoS, handling service that the content provider supports; and
store the first information.
